(19) United States
(12) Patent Application Publication
(10) Pub. No.: US 2025/0315967 A1
(43) Pub. Date: Oct. 9, 2025

(54) Generating Shape Models Through Stereo Thermoclinometry

(71) Applicants: Koundinya Kuppa, Boulder, CO (US); Jay W. McMahon, Boulder, CO (US); Ann B. Dietrich, Boulder, CO (US)

(72) Inventors: Koundinya Kuppa, Boulder, CO (US); Jay W. McMahon, Boulder, CO (US); Ann B. Dietrich, Boulder, CO (US)

(21) Appl. No.: 19/171,692

(22) Filed: Apr. 7, 2025

Related U.S. Application Data
(60) Provisional application No. 63/574,948, filed on Apr. 5, 2024.

(51) Int. Cl. G06T 7/55; G06T 7/73; G06T 17/00; G06T 19/20

(52) U.S. Cl. CPC G06T 7/55; G06T 7/73; G06T 17/00; G06T 19/20; G06T 2207/10048; G06T 2219/2021

(57) ABSTRACT

A method for estimating a shape of an astronomical body includes receiving a number of thermal images of the astronomical body, receiving an initial shape model of the astronomical body, the shape model having a number of surface segments defined by a number of parameter values; updating the shape model based at least in part on a thermal model of the astronomical body and the thermal images. The updating includes determining a surface orientation on at least some of the surface segments based at least in part on the thermal model of the astronomical body and the thermal images and updating the of parameter values according to the surface orientations to yield an updated shape model.

### CROSS-REFERENCES TO RELATED APPLICATIONS

This application claims the benefit of U.S. Provisional Application No. 63/574,948 filed Apr. 5, 2024, the entire contents of which are incorporated herein by reference.

### BACKGROUND OF THE INVENTION

This invention relates to generating a shape model for an astronomical body using stereo-thermoclinometry.

Recent years have shown an increased interest in the study of astronomical bodies such as asteroids and comets. For example, NASA's OSIRIS-Rex mission and the Japanese Space Agency's Hayabusa missions aim to collect samples from an asteroid and return the samples to Earth for analysis. NASA's DART (double asteroid redirection test) aims to test asteroid deflection technology for planetary defense. These types of missions rely on accurate shape characterization of astronomical bodies for spacecraft navigation efforts near the bodies.

In addition to scientific study and spacecraft navigation, accurate shape characterization of astronomical bodies is useful in analyzing the composition of the bodies, identifying of the origin and evolution of bodies (e.g., the formation process of the bodies), and resource utilization for bodies (e.g., for efficiently mining valuable materials).

### SUMMARY OF THE INVENTION

One technique for shape characterization of astronomical bodies is a Shape-from-Silhouette (SfS) algorithm. SfS algorithms use the observed silhouettes of a small body in a series of optical images to infer the shape of the body. While SfS algorithms are able to characterize more shape concavities compared to their ground-based counterparts, concavities that do not appear along the silhouette of the body (e.g., craters) are not observable by SfS algorithms. As a result, SfS algorithms can generate a visual hull of an astronomical body, where the true shape of the astronomical body is contained within the visual hull.

Another technique for shape characterization of astronomical bodies is stereo photoclinometry (SPC), which determines accurate shape models for astronomical bodies from optical images. In general, SPC uses features (e.g., shadows and light direction) in a set of two-dimensional images of a surface to transform the images into a surface map that represents different levels of elevation. SPC is unsuitable for on-board use with spacecraft because it typically requires high-resolution images that make the technique computationally expensive and human input is often required for SPC to converge on an accurate shape of an astronomical body.

Aspects described herein relate to a computationally efficient shape estimation method called stereo thermoclinometry (STC) that can derive accurate shape models of asteroids from a set of infrared (IR) images. Very generally, the algorithm starts with an initial guess of a shape model (e.g., from an SfS algorithm) and knowledge of the material and thermal properties of the body. The algorithm first identifies the surface orientations for a shape model from a set of measured surface temperatures (e.g., from IR images) and predicted sub-surface temperatures (e.g., from a Thermo-Physical Model). Then, an optimization scheme is used to estimate vertices (or other parameters) that correspond to the surface orientations. The estimated vertices are used to generate the shape model.

In a general aspect, a method for estimating a shape of an astronomical body includes receiving a number of thermal images of the astronomical body, receiving a shape model of the astronomical body, the shape model having a number of surface segments defined by a number of parameter values, and updating the shape model based at least in part on a thermal model of the astronomical body and the thermal images. The updating includes determining a surface orientation on at least some of the surface segments based at least in part on the thermal model of the astronomical body and the thermal images and updating the of parameter values according to the surface orientations to yield an updated shape model.

Aspects may include one or more of the following features. The surface segments may include facets, the parameter values may include coordinates of vertices, and updating the parameter values may include updating the coordinates of the vertices. The shape model of the astronomical body may be determined from the thermal images of the astronomical body. The thermal model of the astronomical body may be based at least in part on the shape model, temperatures associated with the surface segments of the shape model, thermal properties of the astronomical body, and a location of the sun relative to the astronomical body. The temperatures may include, for each surface segment, a measured surface temperature of the surface segment and a number of predicted sub-surface temperatures for the surface segment. The measured surface temperature may be determined from the thermal images of the astronomical body.

The method may include updating the thermal model using the updated shape model and predicting surface temperatures for the surface segments of the updated shape model using the updated thermal model. The method may include comparing the predicted surface temperatures for the surface segments of the updated shape model to measured surface temperatures from the thermal images to determine an error between the predicted surface temperatures and the measured surface temperatures. The method may include comparing the error to a predetermined threshold and performing another update of the shape model if the error exceeds the predetermined threshold.

Updating the parameter values according to the estimated orientations may include using an optimization algorithm. The optimization algorithm may include a constrained optimization algorithm. The optimization algorithm may include a trust-region optimization algorithm. The optimization algorithm may include an interior-point method. Determining a surface orientation on at least some of the surface segments may include performing surface clinometry. The thermal images may include infrared images. The thermal model may include a thermophysical model. The initial shape model may be formed using a shape-from-silhouette technique.

In another general aspect, a system for estimating a shape of an astronomical body includes a first input for receiving a number of thermal images of the astronomical body, a second input for receiving a shape model of the astronomical body, the shape model having a number of surface segments defined by a number of parameter values, and at least one processor configured to update the shape model based at least in part on a thermal model of the astronomical body and the thermal images. Updating the shape model. includes determining a surface orientation on at least some of the surface segments based at least in part on the thermal model of the astronomical body and the thermal images and updating the parameter values according to the surface orientations to yield an updated shape model.

In another general aspect, software embodied on a non-transitory, computer readable medium includes instructions for causing a computing system to receive a number of thermal images of the astronomical body, receive a shape model of the astronomical body, the shape model having a number of surface segments defined by a number of parameter values, and update the shape model based at least in part on a thermal model of the astronomical body and the thermal images. Updating the shape model includes determining a surface orientation on at least some of the surface segments based at least in part on the thermal model of the astronomical body and the thermal images and updating the parameter values according to the surface orientations to yield an updated shape model.

Among other advantages, shape models determined using STC show an approximately 80% reduction in errors (on average) compared with an initial shape model. Due to the computational efficiency of STC and its elimination of humans from the estimation process, STC is advantageously usable autonomously, on-board a spacecraft.

Aspects advantageously determine shape models that are accurate enough to be scientifically valuable and to ensure successful operations and navigation in the proximity of astronomical bodies. Aspects advantageously generate higher quality shape models than can be derived using lightcurve data from ground-based telescopes because those aspects are not subject to certain limitations (e.g., atmospheric limitations) experienced when performing observational geometry from Earth.

Other features and advantages of the invention are apparent from the following description, and from the claims.

### BRIEF DESCRIPTION OF THE DRAWINGS

FIG. 1 is a stereo thermoclinometry system.

FIG. 2 is a surface boundary condition.

FIG. 3 is a triangular facet.

FIG. 4 shows thermal images of an asteroid being captured.

FIG. 5 shows an initial shape model.

FIG. 6 shows estimated orientations of facets of an updated shape model.

FIG. 7 shows estimation of vertices of the updated shape model.

FIG. 8 shows the updated shape model.

### DETAILED DESCRIPTION

### 1 Overview

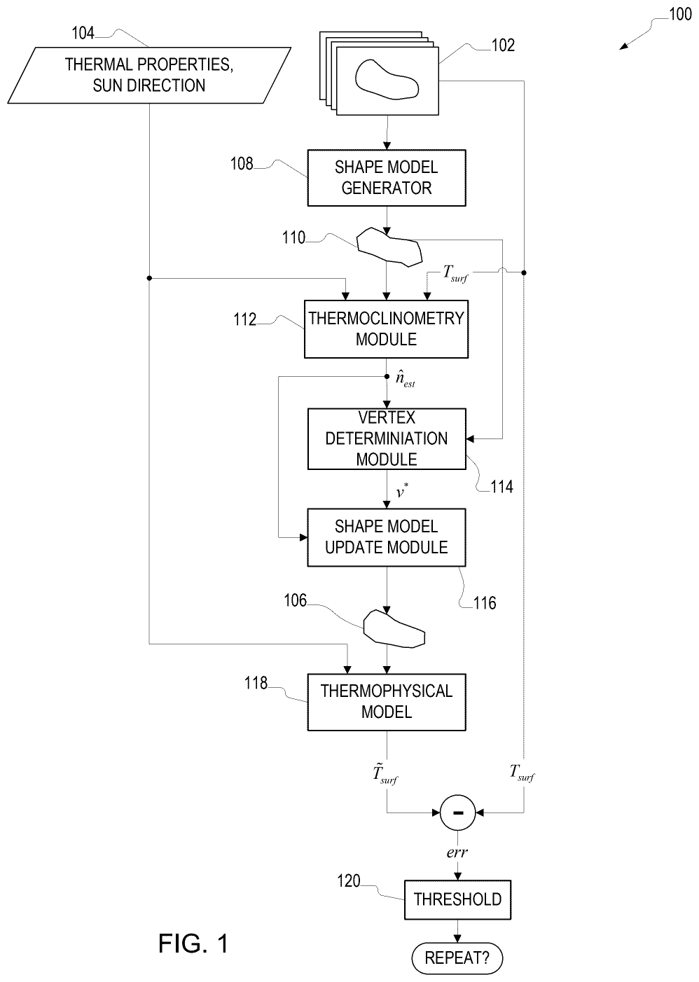

Referring to FIG. 1, a system 100 is configured to generate a shape model of an asteroid. The system 100 receives a number of thermal images 102 of the asteroid and thermophysical model properties 104 as input and processes the thermal images 102 and thermophysical model properties 104 to generate an updated shape model 106 for the asteroid. As is described in greater detail below, using thermal images rather than optical images allows the system 100 to leverage a powerful thermophysical model to determine the updated shape model 106 for the asteroid.

The thermal images 102 are captured as the asteroid rotates, resulting in a set of thermal images that represents the asteroid (or one or more regions of the asteroid) from many different perspectives. For example, the thermal images 102 may include ˜75 images taken over a single rotation of the asteroid. The thermal images are then provided to a shape model generator 108 that generates an initial shape model 110. In some examples, the shape model generator 108 uses a shape-from-silhouette (SfS) algorithm to generate the initial shape model 110 from observed silhouettes of the asteroid in the thermal images 102. In some examples, the SfS algorithm computes the initial shape model 110 of the asteroid by analyzing projected outlines of the asteroid from multiple viewing angles represented in the thermal images 102. By intersecting the volumes defined by these silhouettes, the algorithm reconstructs a 3D approximation of the asteroid's shape. In some examples, the shape estimate is refined by incorporating rotational data and shadowing effects.

In some examples, the initial shape model 110 has a number of facets (e.g., triangular facets) with shapes and orientations defined by vertices. In other examples, other types of shape models are used (e.g., a spline-based shape model).

### 2 Shape Model Refinement

The initial shape model 100 is refined using a two-step refinement technique. In a first step of the technique, a thermoclinometry module 112 is used to estimate orientations of the facets, \hat{n}ₑₛₜ of the updated shape model 106 (a process referred to as “thermoclinometry”). In a second step of the technique, a vertex determination module 114 performs an optimization technique to estimate locations of the vertices, v* of the shape model according to the estimated orientations of the facets, \hat{n}ₑₛₜ.

### 2.1 Thermoclinometry

To determine the estimated facet orientations, \hat{n}ₑₛₜ for the updated shape model 106, the initial shape model 110, the thermophysical model properties 104 (e.g., estimated thermal properties of the asteroid and a direction of the sun relative to the asteroid), and the thermal images 102 are provided to the thermoclinometry module 112. Very generally, the thermoclinometry module 112 is based on a thermophysical model that simulates the thermodynamics of the asteroid.

### 2.1.1 Thermo-Physical Model

Given the sun direction, an initial shape model, and physical properties of a small body, a Thermo-Physical Model (TPM) can be used to simulate the thermodynamics of the body. Such TPMs can be used to model the temperatures of the body over time as different parts of the surface get illuminated by the sun. In general, TPMs numerically integrate the heat equation

$$\frac{\partial T}{\partial t} = \frac{κ}{ρ {C}_{p}} \frac{{\partial }^{2} T}{\partial {z}^{2}}$$

for a given surface element (e.g. a facet of a shape model). This form of the heat equation assumes that the thermal conductivity κ is not a function of depth z.

Two boundary conditions are required to solve the partial differential equation above: (1) an internal boundary condition that dictates a depth at which the temperature stops changing

$${Internal BC : \frac{\partial T}{\partial z} \vert}_{z ≫ {l}_{s}} = 0$$

and (2) a surface boundary condition that dictates the energy balance at the surface of the facet element

$$Surface BC : {F}_{s u n} + {F}_{c o n d} - {F}_{r a d} = 0$$

where

$$Skin Depth Parameter : {l}_{s} = \sqrt{\frac{κ {P}_{r o t}}{2 π ρ {C}_{p}}}$$

$$Energy Radiated ( Sun ) : {F}_{s u n} = \frac{{S}_{⊙} ( 1 - A )}{{R}_{A U}^{2}} cos ( α ) ( 1 - s )$$

$${Energy Conducted : {F}_{c o n d} = κ \frac{dT}{dz} \vert}_{surf}$$

$$Energy Radiated ( space ) : {F}_{r a d} = {ϵ}_{B} {σ}_{SB} {T}_{surf}^{4}$$

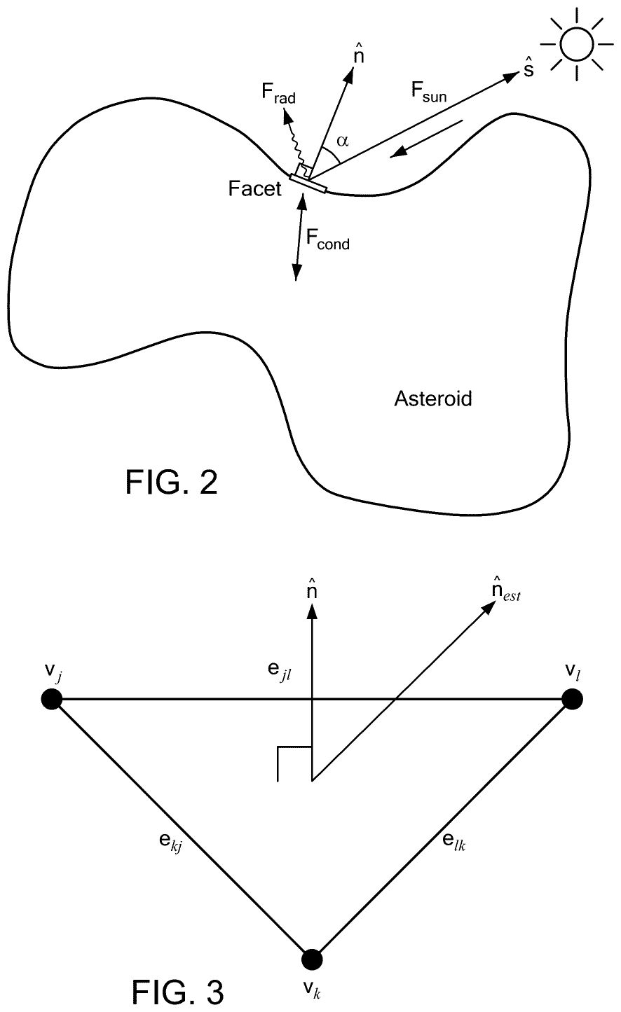

The internal boundary condition defines that at a depth z of several multiples of the skin depth parameter, lₛ, the temperature stops changing (i.e. the thermal gradient is zero). Referring to FIG. 2, an illustration of the surface boundary condition for a facet is shown. The surface boundary condition dictates that the energy radiated from the sun, Fₛᵤₙ plus the energy conducted through the surface, F_{cond} be equal to the energy radiated to space F_{rad} (i.e. the energy is conserved). The angle between the sun direction, ŝ and the facet normal, \hat{n} is defined as the incidence angle, α and determines how much energy from the sun is input to the surface.

In some examples, TPMs discretize the surface into several nodes along the depth z direction for a set multiple of the skin depth, lₛ and then use a finite difference scheme to propagate each node forward in time.

One typical use of a thermophysical model is to estimate sub-surface temperatures and surface temperatures for the facets of a shape model using thermophysical model properties and the shape model. But the system 100 of FIG. 1 already has the surface temperatures for the facets of the shape model from the thermal images 102. On the other hand, the system 100 only has a “rough” initial shape model 110. So, the thermoclinometry module 112 inverts the thermophysical model and uses the inverted model to determine estimated facet orientations, \hat{n}ₑₛₜ for the updated shape model 106 based on the thermal images 102, the thermophysical model properties 104, and the initial shape model 110.

In one example, the thermoclinometry module 112 operates according to two steps: (1) an incidence angle estimation step and (2) a facet normal estimation step.

### 2.1.2 Incidence Angle Estimation

As the surface boundary condition (described above) depends on the incidence angle α, it can be rearranged to solve for this quantity for a given facet as follows:

$${cos ( α ) = \frac{{R}_{A U}^{2}}{{S}_{⊙} ( 1 - A ) ( 1 - s )} [ {ϵ}_{B} {σ}_{SB} {T}_{surf}^{4} - κ \frac{dT}{dz} \vert}_{surf} ]$$

The thermal conduction at the surface can be approximated using a finite difference scheme, as follows:

$${\frac{dT}{dz} \vert}_{surf} \approx \frac{{T}_{ss} - {T}_{surf}}{δ z}$$

where T_{surf} is the surface temperature, Tₛₛ is the temperature at one node below the surface and δz is the depth discretization. From thermal images using an on-board infrared camera, surface temperature measurements, T_{surf} can be obtained. A TPM can be used to make predictions of the sub-surface temperatures, \tilde{T}ₛₛ. Using the two quantities, an estimate of the incidence angle for a given facet can be obtained as follows:

$$cos ( α ) = \frac{{R}_{A U}^{2}}{{S}_{⊙} ( 1 - A ) ( 1 - s )} [ {ϵ}_{B} {σ}_{SB} {T}_{surf}^{4} - κ \frac{{T}_{ss} - {T}_{surf}}{δ z} ]$$

The equation above can be used to derive an incidence angle estimate for all facets of a shape model at a given time.

### 2.1.3 Facet Normal Estimation

As is shown in FIG. 2, the incidence angle is the angle between a facet's normal vector, \hat{n} and the sun direction, ŝ as follows:

$$[ \begin{matrix}cos ( {i}_{1} ) \\ cos ( {i}_{2} ) \\ ⋮ \\ cos ( {i}_{m} )\end{matrix} ] = [ \begin{matrix}{\hat{s}}_{1}^{T} \hat{n} \\ {\hat{s}}_{2}^{T} \hat{n} \\ ⋮ \\ {\hat{s}}_{m}^{T} \hat{n}\end{matrix} ] = [ \begin{matrix}{\hat{s}}_{1}^{T} \\ {\hat{s}}_{2}^{T} \\ ⋮ \\ {\hat{s}}_{m}^{T}\end{matrix} ] \hat{n}$$

An estimate for the facet normal, \hat{n}ₑₛₜ can be obtained by solving the equation immediately above for \hat{n} as follows:

$$A = [ \begin{matrix}{\hat{s}}_{1}^{T} \\ {\hat{s}}_{2}^{T} \\ ⋮ \\ {\hat{s}}_{m}^{T}\end{matrix} ] b = [ \begin{matrix}cos ( {i}_{1} ) \\ cos ( {i}_{2} ) \\ ⋮ \\ cos ( {i}_{m} )\end{matrix} ]$$

$${\hat{n}}_{est} = {( {A}^{T} A )}^{- 1} {A}^{T} b$$

Since the facet normal is a signed unit vector in R³, at least three incidence angle measures are used to obtain a facet normal estimate. In addition, the matrix A is full rank in order for the matrix A^{T}A to be invertible.

### 2.2 Vertex Location Estimation

Referring again to FIG. 1, the estimated facet orientations, \hat{n}ₑₛₜ and the initial shape model 110 are provided to a vertex determination module 114, which uses an optimization technique to determine a set of vertices, v* for the updated shape model 106 according to the estimated facet orientations. In some examples, constrained optimization technique such as an interior point method is used to determine the set of vertices, v*.

In some examples, the normal estimates, \hat{n}ₑₛₜ are used to correct the surface orientations of the shape model from their initial values. To obtain the corresponding shape model vertices, a constrained optimization problem is constructed. The general constrained optimization problem is summarized as follows:

$$min F ( x )$$

$$subject to {g}_{i} ( x ) = {c}_{i} for i = 1 , … , n ( Equality Contraints )$$

$${h}_{i} ( x ) = {d}_{j} for j = 1 , … , n ( Inequality Contraints )$$

The cost function residual, cost function gradient, and the constraints are described in succession below.

Cost Function Residual: Referring to FIG. 3, a triangular facet of a shape model includes three vertices, vⱼ, vₖ, and vₗ three edges, eⱼ, eₖ, and eₗ. The facet normal vector, \hat{n} can be expressed as a function of the three vertices or as a function of two of the three edges as follows:

$$\hat{n} = \frac{( {v}_{k} - {v}_{j} ) \times ( {v}_{j} - {v}_{l} )}{‖ ( {v}_{k} - {v}_{j} ) \times ( {v}_{j} - {v}_{l} ) ‖} = \frac{{e}_{kj} \times {e}_{jl}}{‖ {e}_{kj} \times {e}_{jl} ‖}$$

$$where$$

$${e}_{kj} = {v}_{k} - {v}_{j}$$

$${e}_{jl} = {v}_{j} - {v}_{l}$$

The three edge vectors of a given facet are orthogonal to the normal vector:

$$\hat{n} \cdot {e}_{kj} = \hat{n} \cdot {e}_{jl} = \hat{n} \cdot {e}_{lk} = 0$$

Given an estimate, \hat{n}ₑₛₜ of the normal vector from the thermoclinometry module, a residual between it and the edge vectors for facet i is formatted as follows:

$${r}_{i} = {( {\hat{n}}_{est , i} \cdot {e}_{kj} )}^{2} + {( {\hat{n}}_{est , i} \cdot {e}_{kj} )}^{2} + {( {\hat{n}}_{est , i} \cdot {e}_{kj} )}^{2}$$

$${\hat{n}}_{est} \to \hat{n} {r}_{i} \to 0$$

Optimization Cost Function: As \hat{n}ₑₛₜ approaches the true value, \hat{n}, the residual approaches zero. With this property in mind, an optimization scheme is designed to identify the vertices of the shape model that minimize the sum of the residuals, rᵢ for M facets:

$$x = [ \begin{matrix}{v}_{1} \\ {v}_{2} \\ {v}_{3} \\ ⋮ \\ {v}_{N}\end{matrix} ] ( State Vector )$$

$$F ( x ) = {\sum }_{i = 1}^{M} {r}_{i} ( Cost Function )$$

$${x}^{*} = {arg min}_{x} F ( x )$$

In some examples, a gradient is used to minimize the cost function:

$$\frac{\partial F}{\partial x} = \frac{1}{2} {\sum }_{i = 1}^{N} \frac{\partial {r}_{i}}{\partial x}$$

$$\frac{\partial {r}_{i}}{\partial x} = 2 {\hat{n}}_{est , i}^{T} [ {e}_{kj} ( {\hat{n}}_{est , i}^{T} \frac{\partial {e}_{kj}}{\partial x} ) + {e}_{jl} ( {\hat{n}}_{est , i}^{T} \frac{\partial {e}_{jl}}{\partial x} ) + {e}_{lk} ( {\hat{n}}_{est , i}^{T} \frac{\partial {e}_{lk}}{\partial x} ) ]$$

The cost function is thus minimized when the following gradient is zero:

$${\frac{\partial F}{\partial x} \vert}_{{x}^{*}} = 0$$

Constraints: As the initial model is expected to be derived using an SfS algorithm, it is expected to represent the visual hull of the body, where the true shape is within the visual hull. This visual hull constraint is added to the optimization scheme to facilitate faster convergence. This inequality constraint ensures that each of the vertices in the state vector x is within the visual hull of the initial shape model.

In addition, as the cost function is minimized when all vertices are placed at origin (since the edges are zero), a minimum radius constraint is added to each vertex to prevent the optimizer from converging to this trivial solution.

Lastly, the facets of the resultant shape model should not be overlapping or intersecting. Intersections between facets in the shape model are computed from which a Boolean is derived that determines whether one or more intersections exist (true) or not (false). An equality constraint enforcing that this Boolean be false is added to the optimization scheme to prevent intersecting facets.

### 3 Iterative Refinement of the Shape Model

The estimated facet orientations, \hat{n}ₑₛₜ and the set of vertices, v* are provided to a shape model update module 116, which combines the facet orientations and vertices to generate the updated shape model 106.

The updated shape model 106 and the thermophysical model properties 104 are provided to a non-inverted configuration of the thermophysical model 118, which determines estimated surface temperatures, \tilde{T}_{surf} for the facets of the updated shape model 106 from the updated shape model 106 and the thermophysical model properties 104. The estimated surface temperatures, \tilde{T}_{surf} are compared to the measured surface temperatures, T_{surf} from the thermal images 102 to determine an error signal, err (representing how closely the shape of the updated shape model 106 matches the actual shape of the asteroid). The error signal, err is then compared to a threshold 120 to determine whether the process needs to be repeated to refine the updated shape model 106.

If further refinement of the shape model is necessary, the thermoclinometry process described above is repeated using the updated shape model 106 as input rather than the initial shape model 110. Once error signal, err is below the threshold 120, the system 100 outputs the updated model 106 as the final estimate of the shape of the asteroid.

### 4 Simplified Example

Referring to FIG. 4-8, a simplified, two-dimensional example of the operation of the system of FIG. 1 is presented.

Referring specifically to FIG. 4, the system first receives n thermal images 102 captured as an asteroid 222 rotates.

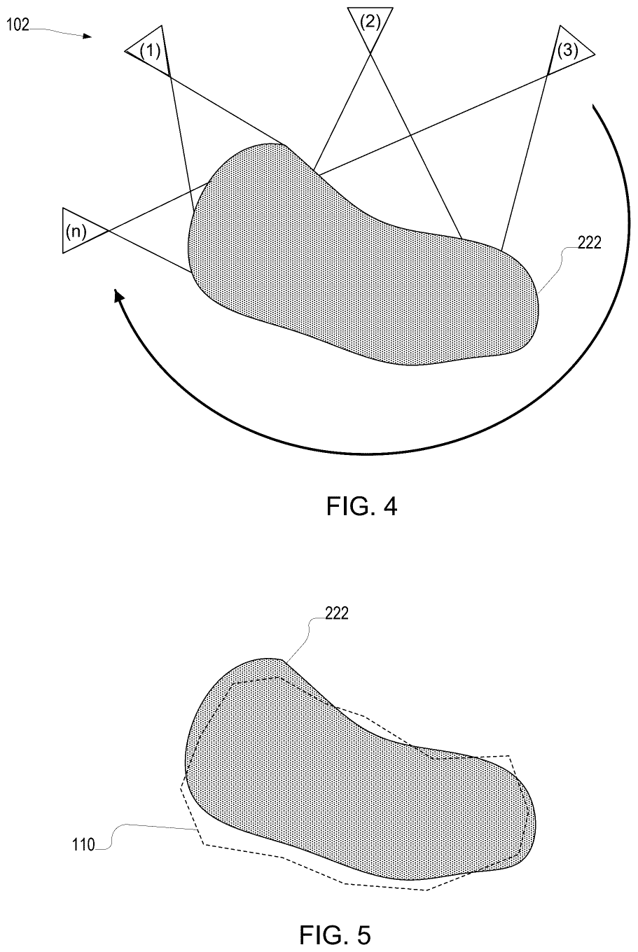

Referring to FIG. 5, an initial shape model 110 of the asteroid 222 is generated by, for example, processing the thermal images 102 using a shape-from-silhouette (SfS) technique.

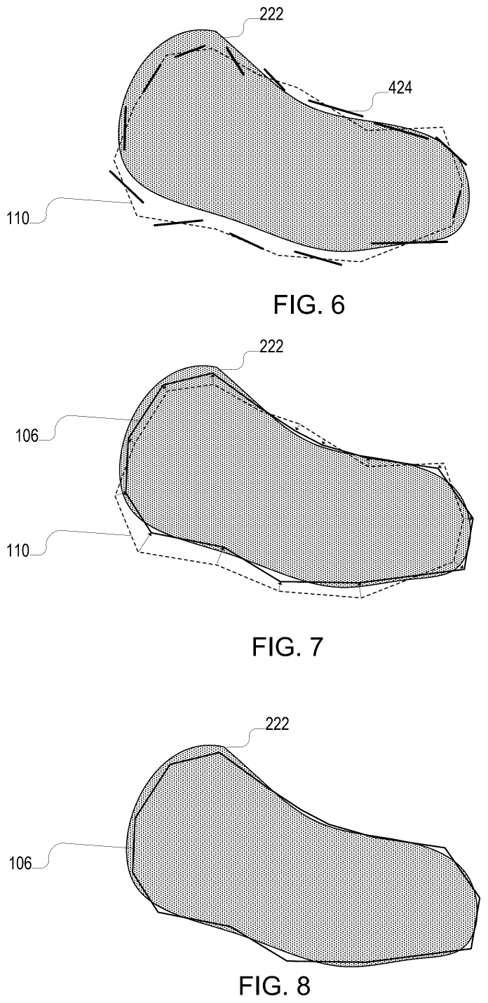

Referring to FIG. 6, the thermoclinometry module 112 of FIG. 1 is used to determine estimated facet orientations, \hat{n}ₑₛₜ 424 using the initial shape model 110, the thermal images 102, and model parameters 104, as described above.

Referring to FIG. 7, an optimization technique is then used to determine the set of vertices, v* for the updated shape model 106 (e.g., by moving the vertices, as shown in the figure based on the estimated facet orientations, \hat{n}ₑₛₜ). Referring to FIG. 8, the resulting updated shape model 106 is an improved representation of the shape of the asteroid 222.

### 5 Alternatives

While the examples described above are presented in the context of estimating a shape of an asteroid, the techniques described herein have broader applications including estimation of the shapes of other types of astronomical bodies (e.g., comets and moons) and other types of objects with unknown shapes.

Other types of optimization techniques may be used to determine the estimated set of vertices for the updated shape model. For example, trust-region optimization algorithms or simulated annealing algorithms could be used.

The techniques described above are applicable to different types of shape models in addition to shape models with facets and vertices. For example, the shape model may be a spline-based shape model, where surface segments of the model are defined by splines and control points, and knots of the shape model are adjusted to update the shape model.

### 6 Implementations

The computational resource allocation approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for estimating a shape of an astronomical body, the method comprising:
receiving a plurality of thermal images of the astronomical body;
receiving a shape model of the astronomical body, the shape model having a plurality of surface segments defined by a plurality of parameter values; and
updating the shape model based at least in part on a thermal model of the astronomical body and the plurality of thermal images, the updating including:
determining a surface orientation on at least some surface segments of the plurality of surface segments of the shape model based at least in part on the thermal model of the astronomical body and the plurality of thermal images; and
updating the plurality of parameter values according to the surface orientations to yield an updated shape model.

2. The method of claim 1 wherein the surface segments include facets, the parameter values include coordinates of vertices, and updating the plurality of parameter values includes updating the coordinates of the vertices.

3. The method of claim 1 wherein the shape model of the astronomical body is determined from the plurality of thermal images of the astronomical body.

4. The method of claim 1 wherein the thermal model of the astronomical body is based at least in part on the shape model, temperatures associated with the surface segments of the shape model, thermal properties of the astronomical body, and a location of the sun relative to the astronomical body.

5. The method of claim 4 wherein the temperatures include, for each surface segment of the plurality of surface segments, a measured surface temperature of the surface segment and a plurality of predicted sub-surface temperatures for the surface segment.

6. The method of claim 5 wherein the measured surface temperature is determined from the plurality of thermal images of the astronomical body.

7. The method of claim 1 further comprising updating the thermal model using the updated shape model and predicting surface temperatures for the surface segments of the updated shape model using the updated thermal model.

8. The method of claim 7 further comprising comparing the predicted surface temperatures for the surface segments of the updated shape model to measured surface temperatures from the plurality of thermal images to determine an error between the predicted surface temperatures and the measured surface temperatures.

9. The method of claim 8 further comprising comparing the error to a predetermined threshold and performing another update of the shape model if the error exceeds the predetermined threshold.

10. The method of claim 1 wherein updating the plurality of parameter values according to the estimated orientations includes using an optimization algorithm.

11. The method of claim 10 wherein the optimization algorithm includes a constrained optimization algorithm.

12. The method claim 11 wherein the optimization algorithm includes an interior-point method.

13. The method of claim 10 wherein the optimization algorithm includes a trust-region optimization algorithm.

14. The method of claim 1 wherein determining a surface orientation on at least some surface segments of the plurality of surface segments of the shape model includes performing surface clinometry.

15. The method of claim 1 wherein the thermal images include infrared images.

16. The method of claim 1 wherein the thermal model includes a thermophysical model.

17. The method of claim 1 further comprising forming the shape model of the astronomical body using a shape-from-silhouette technique.

18. The method of claim 1 wherein the astronomical body is an asteroid.

19. A system for estimating a shape of an astronomical body, the system comprising:
a first input for receiving a plurality of thermal images of the astronomical body;
a second input for receiving a shape model of the astronomical body, the shape model having a plurality of surface segments defined by a plurality of parameter values;
at least one processor configured to update the shape model based at least in part on a thermal model of the astronomical body and the plurality of thermal images, the updating including:
determining a surface orientation on at least some surface segments of the plurality of surface segments of the shape model based at least in part on the thermal model of the astronomical body and the plurality of thermal images; and
updating the plurality of parameter values according to the surface orientations to yield an updated shape model.

20. Software embodied on a non-transitory, computer readable medium, the software comprising instructions for causing a computing system to:
receive a plurality of thermal images of the astronomical body;
receive a shape model of the astronomical body, the shape model having a plurality of surface segments defined by a plurality of parameter values;
update the shape model based at least in part on a thermal model of the astronomical body and the plurality of thermal images, the updating including:
determining a surface orientation on at least some surface segments of the plurality of surface segments of the shape model based at least in part on the thermal model of the astronomical body and the plurality of thermal images; and
updating the plurality of parameter values according to the surface orientations to yield an updated shape model.
